(19) United States
(12) Patent Application Publication
(10) Pub. No.: US 2010/0328545 A1
(43) Pub. Date: Dec. 30, 2010

(54) RECEIVER SYSTEM AND METHOD OF RECEIVING A BROADCAST TO PROVIDE A CONTENT OUTPUT

(75) Inventors: NIEL D. BEDWELL, NOBLESVILLE, IN (US); TODD M. BRANDENBURG, KOKOMO, IN (US)

Correspondence Address: DELPHI TECHNOLOGIES, INC, M/C 480-410-202, PO BOX 5052, TROY, MI, 48007, US

(73) Assignee: DELPHI TECHNOLOGIES, INC., TROY, MI (US)

(21) Appl. No.: 12/491,631

(22) Filed: Jun. 25, 2009

(51) Int. Cl. H04N 5/50

(52) U.S. Cl. 348/731; 348/E05.097

(57) ABSTRACT

A receiver system and method of receiving a plurality of channels to provide a content output are provided, the system including at least one antenna configured to receive a plurality of channels, each channel of the plurality of channels being at a different frequency. The receiver further includes a tuner in communication with the at least one antenna, wherein the tuner is configured to receive a first channel of the plurality of channels at a first frequency during a first period of time, at least a second channel of the plurality of channels at a second frequency during a second period of time, and provide a content output based upon only the first channel substantially without interruption during both first and second periods of time.

### TECHNICAL FIELD

The present invention generally relates to a receiver system and method thereof, and more particularly, to a receiver system and method thereof for providing a content output based upon a channel previously received, while receiving another channel.

### BACKGROUND OF THE INVENTION

Generally, the Advanced Television Systems Committee (ATSC) document number A/153 is a candidate standard from the ATSC, named the ATSC-M/H Standard, and commonly referred to as the Mobile Digital Television (Mobile DTV) Standard. The standard is generally intended to add extra robustness to the existing ATSC Digital Television Standard, Document A/53 to allow for improved performance in the presence of Doppler and multipath conditions as observed in a mobile environment. Typically, an M/H service and all necessary signaling information are to be carried within, and without interfering with, the legacy standard, at determinant intervals that are provided from data carried within the ATSC-M/H system. By knowing when wanted packets are to be received, power moding of receivers can be utilized to conserve power.

It is generally not easy for the candidate standard to determine what channels are available for a specific receiver at a specific geographic location. The current method for determining channel availability typically requires a scan of all applicable frequencies for M/H content; a process that is very time consuming. The available channels can also change rapidly as the user's geographic location and reception environment change. Typically, another channel scan is then required to discover these changes, which interrupts the user's experience.

### SUMMARY OF THE INVENTION

In accordance with one aspect of the present invention, a receiver system includes at least one antenna configured to receive a plurality of channels, each channel of the plurality of channels being at a different frequency and a tuner in communication with the at least one antenna, wherein the tuner is configured to receive a first channel of the plurality of channels at a first frequency during a first period of time, at least a second channel of the plurality of channels at a second frequency during a second period of time, and provide a content output based upon only the first channel substantially without interruption during both the first and second periods of time.

According to another aspect of the present invention, a receiver system used with a vehicle includes at least one antenna configured to receive a plurality of Advanced Television Systems Committee M/H A/153 (ATSC-M/H A/153) channels, each channel of the plurality of channels being at a different frequency and comprising a plurality of data slots and a tuner in communication with the at least one antenna, wherein the tuner is configured to receive a first channel of the plurality of channels at a first frequency during a first period of time that corresponds to a time period of at least a first data slot of a plurality of data slots of the first channel, at least a second channel of the plurality of channels at a second frequency during a second period of time, that corresponds to a time period of at least a second data slot of a plurality of data slots of the first channel, providing a content output based upon only the first channel substantially without interruption during both first and second periods of time, and return to receiving the first channel after the second period of time expires.

According to yet another aspect of the present invention, a method of receiving a broadcast to provide a content output is provided, the method including the steps of receiving a plurality of channels, each channel of the plurality of channels being a different frequency, tuning to a first channel of the plurality of channels at a first frequency during a first period of time, tuning to at least a second channel of the plurality of channels at a second frequency during a second period of time, and providing a content output based upon only the first channel substantially without interruption during both the first and second periods of time.

These and other features, advantages and objects of the present invention will be further understood and appreciated by those skilled in the art by reference to the following specification, claims and appended drawings.

### BRIEF DESCRIPTION OF THE DRAWINGS

The present invention will now be described, by way of example, with reference to the accompanying drawings, in which:

FIG. 1 is a block diagram of a receiver system, in accordance with one embodiment of the present invention;

FIG. 2 is a diagram illustrating the plurality of data slots in a channel of a signal, in accordance with one embodiment of the present invention; and

FIG. 3 is a flowchart illustrating a method of receiving a signal to provide a content output, in accordance with one embodiment of the present invention.

### DESCRIPTION OF EMBODIMENTS

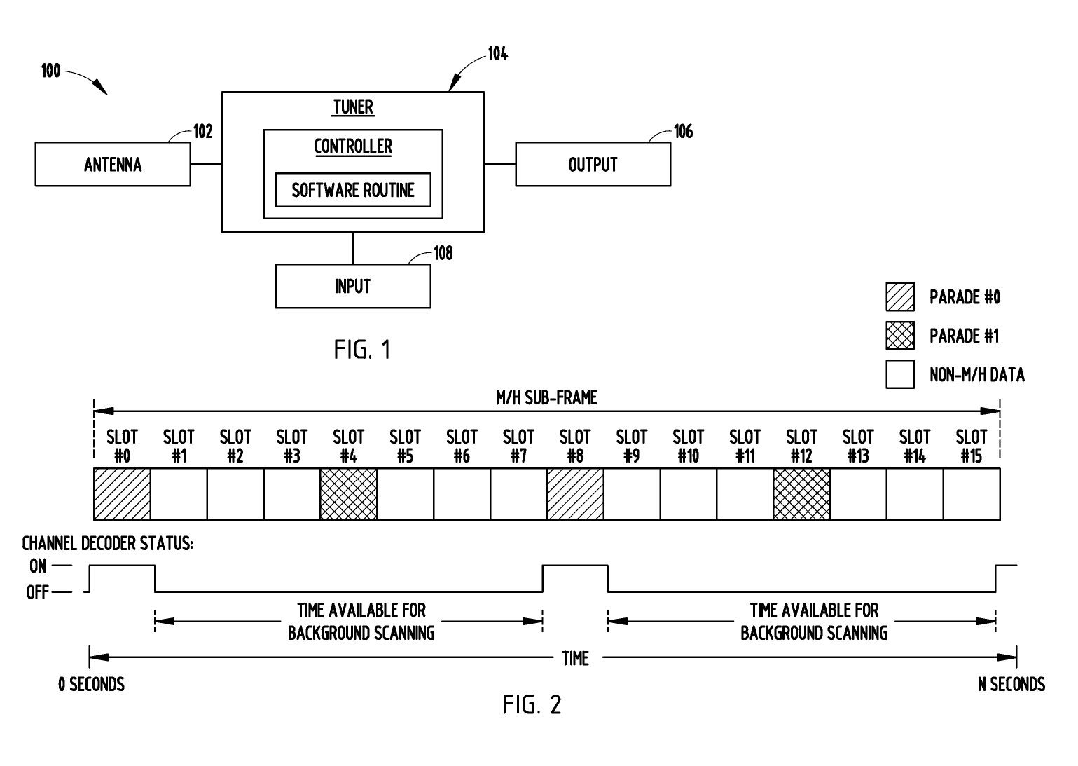

In regards to both FIGS. 1 and 2, a receiver system is generally shown in FIG. 1 at reference identifier 100. The receiver system 100 includes at least one antenna 102 configured to receive a plurality of channels, wherein each channel of the plurality of channels is at a different frequency. The system 100 further includes a tuner, generally indicated at reference identifier 104, and in communication with the at least one antenna 102, wherein the tuner 104 is configured to receive a first channel of the plurality of channels at a first frequency during a first period of time, at least a second channel of the plurality of channels at a second frequency during a second period of time, and provide a content output 106 based upon only the first channel substantially without an interruption during both first and second periods of time, as described in greater detail herein.

Thus, the receiver system can receive the second channel to determine if content, what content, or a combination thereof, is being broadcast on the second channel during a second period of time, without interrupting the content output that is provided based upon the first channel. The first channel received during at least the first time period is an adequate amount of data to continue providing the content output even during the second time period. Therefore, the receiver system 100 can determine if content, what content, or a combination thereof, is being broadcast on the one or more channels other than the first channel prior to being specifically instructed by a user to change from the first channel to receiving the second channel (e.g., a user changing channels to switch to a different program).

Typically, when the receiver system 100 waits until specifically instructed by a user to switch channels, there is a time delay where the receiver system 100 changes to a different channel and determines if content, what content, or a combination thereof, is being received prior to being able to provide a content output to the user. It should be appreciated by those skilled in the art that the phrases first time period and second time period are exemplary phrases for identifying and distinguishing time periods, and that these time periods may include the time periods when one or more data slots are being received. It should further be appreciated by those skilled in the art that there may be more than two time periods, and that the first and second time periods are described herein for purposes of explanation and not limitation.

According to one embodiment, the broadcast is an ATSC-M/H A/153 broadcast. Typically, each of the plurality of channels of the broadcast includes a plurality of data slots (e.g., FIG. 2), wherein each data slot corresponds to a time period, and different data is being broadcast during the different data slots. Further, a plurality of parades can be included, which have at least one of a plurality of data slots. Additionally, each or at least a portion of the plurality of channels can include signaling information, such that the tuner 104 receives timing information associated with the first and second periods of time that can correspond to first and second data slots respectively. It should be appreciated by those skilled in the art that at least one of the first and second time periods can correspond to one or more data slots (e.g., as illustrated in FIG. 2, the first time period corresponds to slot #0, and the second time period corresponds to slot #1 through slot #7).

The timing information can include information that corresponds to a time period for which a slot is being received, such that the tuner 104 can perform a scan of different channels during a known period of time (e.g., the second period of time). Typically, the time period for each data slot is substantially the same, but the number of data slots forming the parade can be different. The tuner 104 can receive this timing information to determine the length of time the tuner 104 can scan the other channels.

Typically, the tuner 104 returns to receiving a first channel after the second period of time expires. According to one embodiment, the tuner 104 re-synchronizes with the broadcast when returning to receive the first channel prior to the second period of time expiring. The re-synchronization can be based upon the timing information received by the tuner 104 via the signaling information or data carried within the ATSC-M/H system. The tuner 104 can be a single tuner, such that the provided content output is based upon the signal being received and processed by the single tuner. However, it should be appreciated by those skilled in the art that more than one tuner 104 can be used to receive the signal.

According to another embodiment, the tuner 104 can be activated to turn-off during a second period of time, by receiving an instruction from a user by an input device 108. Additionally or alternatively, the receiver system 100 can be used with a vehicle. Typically, the vehicle is considered to have a greater amount of electrical power to supply to the system 100 when compared to the system 100 being used with a handheld mobile device. Thus, when the system 100 is powered by the vehicle, the user can instruct the tuner 104 to receive the second channel during the second period of time rather than turning off to conserve power.

For purposes of explanation and not limitation, when the system 100 is being used with a vehicle, the tuner 104 can receive the first channel (e.g., slot #0) during the first period of time (e.g., channel decoder status ON) (FIG. 2). The tuner 104 can then conduct background scanning, such that the different channels are scanned while slot #0 is not being broadcasted (e.g., slot #1-slot #7). In the exemplary embodiment of FIG. 2, slot #8 corresponds with slot #0, such that the tuner 104 needs to re-synchronize and receive the data broadcasted at slot #8. Thus, slot #0 and slot #8 correspond to the same parade. The tuner 104 can then conduct background scanning during the time period of slot #9-slot #15 being broadcasted. Therefore, slot #0 and slot #8 are received in order to emit the output 106, while the time period of broadcasting slot #1-slot #7 and slot #9-slot #15 can be used for conducting the background scanning of the channels, and the output 106 based upon slot #0 and slot #8 is continuously being emitted to the user. Typically, when the tuner 104 is conducting a background scan, the tuner 104 is monitoring to detect the presence of another channel and to determine if the channel could be an ATSC-M/H A/153 broadcast.

In such an exemplary embodiment, the system 100 is used with a vehicle, and can continuously monitor the content of the different channels (e.g., the background scanning). The background scanning can be advantageous because the content of the channels can vary based upon geographical location (e.g., local broadcast of channels). Therefore, as the vehicle is travelling through different geographical areas, the system 100 can continuously be conducting background scans to determine if content is available in the non-current channels.

By way of explanation and not limitation, in regards to FIG. 2, the tuner 104 can receive all of the data slots of a parade (e.g., parade #0 including slot #0 and slot #8) to continue to emit the output 106 substantially without interruption, according to one embodiment. Generally, a parade is formed by one or more data slots in the channel, wherein the data slots (e.g., slot #4 and slot #12) of the parade (e.g., parade #1) are spaced (e.g., spaced in time) from one another.

In an embodiment wherein the broadcast is an ATSC-M/H A/153 signal, the M/H data is typically transmitted in a bursty manner. The data to be received is contained in a known parade (i.e., one or more data slots), and each parade is received at times discovered from the M/H data (e.g., the signaling information). When the data being received by the system 100 is not relevant to the output 106, the tuner 104 tunes to other frequencies to determine the M/H availability. When the parade of interest (POI) is to be received, the tuner 104 re-tunes to the appropriate channel with adequate time to re-synchronize with the transmission. Thus, the single tuner 104 can be used to receive a desired data, while also discovering other available data and providing local data (e.g., local television stations) availability.

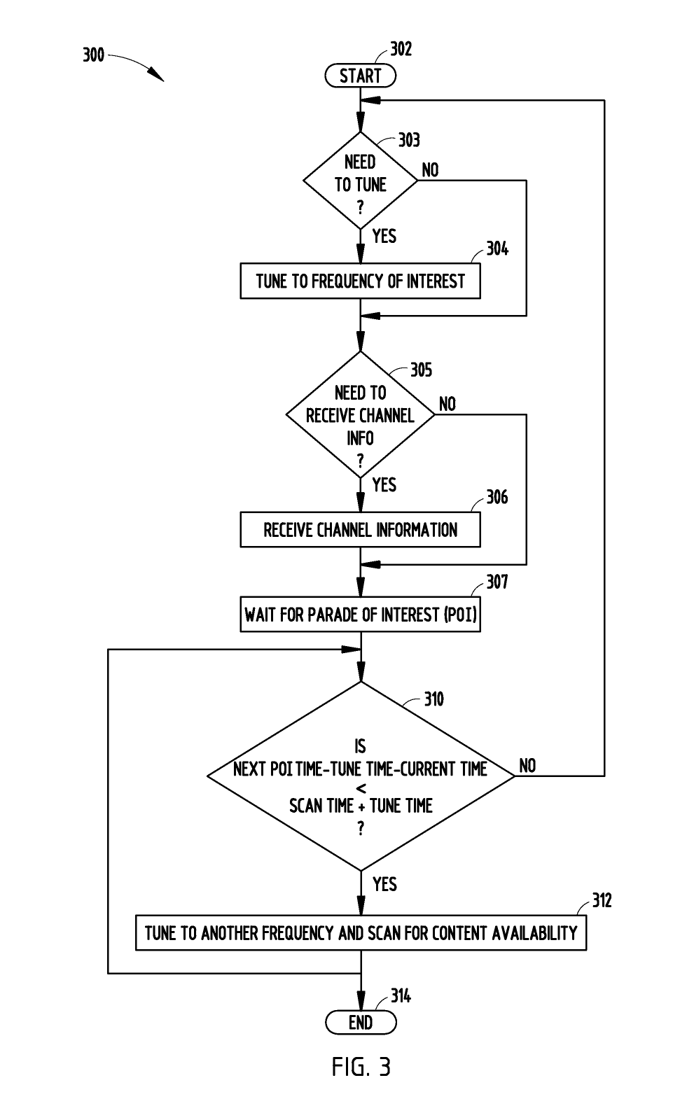

In regards to FIGS. 1-3, a method of receiving data to provide the content output 106 is generally shown in FIG. 3 at reference identifier 300. The method 300 starts at step 302, and proceeds to decision step 303, wherein it is determined if there is a need to tune. Typically, the receiver system 100 needs to tune when a user desires programming to be received, or when the tuner needs to re-synchronize to the parade of interest after a background scan. If it is determined that there is a need to tune at decision step 303, then the method proceeds to step 304, wherein a channel of interest is tuned. Typically, the tuner 104 is used to tune to a desired channel to receive and emit a desired output 106. If it is determined at decision step 303 that there is not a need to tune or after a frequency of interest is received at step 304, the method 300 then proceeds to decision step 305, wherein it is determined if channel information needs to be received. If it is determined at decision step 305 that there is a need to receive channel information, the method 300 then receives channel information at step 306. Typically, the content of the channels or different un-used data slots are determined.

If it is determined at decision step 305 that there is not a need to receive channel information, then the method 300 proceeds to step 308, wherein it is determined if the POI is being received. At decision step 310, it is determined if the next POI time minus the tune time minus the current time is greater than a scanned time plus a tune time. If it is determined at decision step 310 that the next POI time minus the tune time minus the current time is not greater than the scanned time plus the tune time, then the method 300 returns to step 304. However, if it is determined at decision step 310 that the next POI time minus the tune time minus the current time is greater than the scanned time plus the tune time, then the method 300 proceeds to step 312. At step 312, the tuner 104 tunes to another channel and scans for content availability. The method 300 can then return to decision step 310, or end at step 314. Typically, the method 300 continuously loops until electrical power is no longer supplied for the system 100, or if the user of the system 100 instructs the tuner to power down during the second period of time rather than performing a background scan, or if the user of the system 100 instructs the tuner to tune to another channel.

Advantageously, the system 100 and method 300 can be used to determine if and/or what content is being broadcast on different channels during periods of time without interrupting the output to the user, which reduces a time delay when a user does decide to select a different channel for emitting an output. Further, the system 100 and method 300 utilize the ATSC-M/H A/153 signal properties, which are used for mobile devices to power down to conserve power to obtain this additional information. It should be appreciated by those skilled in the art that additional or alternative advantages may be present based upon the system 100 and method 300. It should further be appreciated by those skilled in the art that the above-described elements can be combined in alternative ways that are not explicitly described herein.

Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

1. A receiver system comprising:
at least one antenna configured to receive a plurality of channels, each channel of said plurality of channels being at a different frequency; and
a tuner in communication with said at least one antenna, wherein said tuner is configured to receive a first channel of said plurality of channels at a first frequency during a first period of time, at least a second channel of said plurality of channels at a second frequency during a second period of time, and provide a content output based upon only said first channel substantially without interruption during both said first and second periods of time.

2. The receiver system of claim 1, wherein said plurality of channels are Advanced Television Systems Committee M/H A/153 (ATSC-M/H A/153) channels.

3. The receiver system of claim 1, wherein each channel of said plurality of channels comprise a plurality of data slots, such that at least a portion of the plurality of data slots correspond to one of said first and second periods of time.

4. The receiver system of claim 3, wherein at least one said channel of said plurality of channels further comprises a plurality of parades, each said parade comprising a plurality of data slots.

5. The receiver system of claim 1, wherein each channel of said plurality of channels further comprises signaling information, such that said tuner receives timing information associated with said first and second periods of time.

6. The receiver system of claim 1, wherein said tuner returns to receiving said first channel after said second period of time expires.

7. The receiver system of claim 6, wherein said tuner re-synchronizes with said first channel at said first frequency when returning to receive said first channel.

8. The receiver system of claim 1 further comprising a user input device, wherein said tuner is activated to turn-off during said second period of time.

9. The receiver system of claim 1, wherein said at least one antenna and said tuner are utilized with a vehicle.

10. A receiver system used with a vehicle comprising:
at least one antenna configured to receive a plurality of Advanced Television Systems Committee M/H A/153 (ATSC-M/H A/153) channels, each channel of said plurality of channels being at a different frequency; and
a tuner in communication with said at least one antenna, wherein said tuner is configured to receive a first channel of said plurality of channels at a first frequency during a first period of time that corresponds to a time period of a first data slot of a plurality of data slots of said first channel, at least a second channel of said plurality of channels at a second frequency during a second period of time that corresponds to a time period of at least a second data slot of said plurality of data slots of said first channel, providing a content output based upon only said first channel substantially without interruption during both first and second periods of time, and return to receiving said first channel after said second period of time expires.

11. The system of claim 10, wherein at least a portion of said channels of said plurality of channels further comprises at least one parade, comprising a plurality of data slots.

12. The system of claim 10, wherein said channel of said plurality of channels further comprises signaling information, such that said tuner receives timing information associated with said first and second periods of time.

13. The system as defined in claim 10, wherein said tuner re-synchronizes with said channel when returning to receive said first channel.

14. A method of receiving a plurality of channels to provide a content output, said method comprising the steps of:
receiving a plurality of channels, each channel of said plurality of channels being at a different frequency;
tuning to a first channel of said plurality of channels at a first frequency during a first period of time;
tuning to at least a second channel of said plurality of channels at a second frequency during a second period of time; and
providing a content output based upon only said first channel substantially without interruption during both said first and second periods of times.

15. The method of claim 14, wherein said plurality of channels are Advanced Television Systems Committee M/H A/153 (ATSC-M/H A/153) channels.

16. The method of claim 14, wherein at least one channel of said plurality of channels further comprises at least one parade, comprising a plurality of data slots.

17. The method of claim 14 further comprising the step of receiving signaling information, wherein timing information associated with said first and second periods of time is received.

18. The method of claim 14 further comprising the step of returning to receiving said first channel after said second period of time expires.

19. The method of claim 18 further comprising the step of re-synchronizing with said channel when returning to receive said first channel.

20. The method of claim 14, wherein said step of tuning to at least said second channel is performed when it is determined if a next parade of interest minus a tune time minus a current time is less than a scan time plus a tune time.
